(19) United States
(12) Patent Application Publication
(10) Pub. No.: US 2009/0289405 A1
(43) Pub. Date: Nov. 26, 2009

(54) CLAMPING DEVICE

(75) Inventors: David G. Hill, South Wales (GB); Sarah J. Hill, South Wales (GB)

Correspondence Address: BURR & BROWN, PO BOX 7068, SYRACUSE, NY, 13261-7068, US

(73) Assignee: Shielld Innovations Limited, Birmingham (GB)

(21) Appl. No.: 12/489,665

(22) Filed: Jun. 23, 2009

Related U.S. Application Data
(63) Continuation of application No. PCT/GB2008/000317, filed on Jan. 31, 2008.

(30) Foreign Application Priority Data
Dec. 23, 2006 (GB) 0625908.9

(51) Int. Cl. B25B 5/06

(52) U.S. Cl. 269/254 R

(57) ABSTRACT

A rotary holding unit attached to a body including a plurality of clamping legs which move relative to each other. The unit allows simultaneous operation of either mounting the assembly to a vertical or horizontal edge or securing an object within the fully rotating holding housing. By moving the legs against the biasing force, the unit is prepared for mounting to an edge such as a ladder leg or table. Upon release the unit is automatically secured to the edge by means of the biasing force. Inadvertent movement of the unit once positioned is further limited by grip improving materials. The holding housing—in this case a female dovetail socket capable of receiving and securing a mating male dovetail fitted to or part of an accessory or component—may be rotated to the desired position.

### CROSS REFERENCE TO RELATED APPLICATIONS

This application is a continuation of International Application No. PCT/GB2008/000317, filed Jan. 31, 2008, which designated the United States, and claims the benefit under 35 USC §119(a)-(d) of British Application No. 0625908.9 filed Dec. 31, 2006, the entireties of which are incorporated herein by reference.

### FIELD OF THE INVENTION

The present invention relates to a clamping device which allows an object such as equipment, an implement, or a DIY product to be releasably held in position at a surface edge.

### BACKGROUND OF THE INVENTION

It is often necessary or desirable to temporarily secure an object in a given position, for example close to a workspace or a chosen mounting position, so that the object is readily yet safely accessible. The present invention provides a highly adaptable clamping device or mounting bracket to address this need.

According to a first aspect of the present invention, there is provided a clamping device for holding an object in position at or near a surface edge, the device comprising: a clamping unit for clamping the device to the surface edge, the clamping unit having two, three or more clamping members which are movable relative to each other from a clamping position to a release position; a biasing means operative to provide a biasing force for (normally) biasing the clamping members towards the clamping position; and a holding unit for holding the object, the holding unit being coupled to the clamping unit.

The device allows simultaneous use of the two units which serve to clamp the device to a surface edge and hold the object, respectively. Advantages of the device will be apparent from the further description below.

The clamping unit and optionally the holding unit may be connected to a body.

The clamping unit may comprise two or more movable and preferably naturally opposed clamping arms arranged in a pivotal relationship with each other about the body, with each clamping arm comprising a clamping member, for example at an end of each clamping arm distal from the clamping member.

Furthermore, a clamping member may extend outwardly from the body.

The body is in one aspect centrally located in the device, forming a central body.

Three clamping members (for example, two on the clamping arms and one on the body) may form a three point clamping arrangement.

In use, two or more of the clamping members (for example, those on the clamping arms) may be positioned on one side of the surface edge, with another clamping member (for example, a central clamping member perhaps located on the body) on the other side of the surface edge, the clamping members thereby clamping the device onto the surface edge.

To position or release the clamping device onto or from the surface edge, the clamping members are moved against the biasing force into the release position.

In the device, the biasing means may force the clamping members on the clamping arms into substantially linear alignment on opposite sides of a centrally located clamping member, for example the clamping member on the body or central body. However, the device may comprise a stop means (such as a mechanical stop means) which limits movement of the clamping members relative to each other. The clamping arms may therefore be prevented by the stop means from reaching the substantially linear alignment under the force of the biasing means. The stop means may allow, for example, the biasing force acting on the clamping arms to maintain the clamping arms in a clamping position (in one aspect thereby maintaining sufficient clamping tension in the clamping arms).

The biasing means may comprise a resilient means, for example a spring such as a torsion spring. In one aspect, the biasing means may be located within the clamping arms. For example, the biasing means may be a torsion spring which is mounted and mechanically attached to opposed clamping arms via the (optionally central) body about which the arms pivot.

One or more of the clamping members may be tubular or designed for engaging with a particular surface edge to which the device is clampable.

One or more of the clamping members may comprise or be at least partially covered by a grip-improving material, for example a sleeve of grip-improving material such as a closed-cell self-skinning foam.

The holding unit may be rotatable, for example with respect to the body or a clamping member, to allow an object held within the holding unit to be orientated at a chosen angle.

The holding unit may comprise a stop mechanism, for example a detent mechanism such as a sprung detent mechanism, which operates to restrict free rotation of the holding unit. In this way, the object can be held in position at any given angle (for example, horizontal to ground level) by the holding unit.

To further increase positional control of (an object held by) the holding unit, the holding unit may be articulated and/or may comprise a ball-and-socket joint. This will allow, for example, an object such as a camera or other image-capturing equipment to be positioned as desired by a user.

In one aspect, one or more of the clamping members (for example, a central clamping member), rather the body, may comprise or be connected to the holding unit.

The holding unit may comprise an attachment site onto which the object is releasably attachable. In one aspect, the attachment site comprises one part of a connecting mechanism onto which a corresponding part positioned on, attached to, or integral with the object is connectable. For example, the connecting mechanism may comprise male and female parts which releasably connect with each other. Alternative suitable connecting mechanisms are well known in the art and include “lock and key” and “male and female” mechanisms.

The attachment site may also comprise a lock mechanism for locking the object into the holding unit, thereby preventing accidental release of the object from the holding unit.

One or more of the clamping members, for example a central clamping member or a clamping member located on the holding body, may comprise a securing means for securing the device to the surface. The securing means may comprise a screwable or a lever-operable core plug attachable to a locking cover plate.

The securing means may be a separate and independent component of the clamping device, detachable from the clamping member(s).

At least part of the securing means may be insertable into a clamping member, for example into a hollow internal chamber of a cylindrical clamping member such as a central clamping member (for example, an optionally central body clamping member).

The securing means may be used in safety-critical applications, for example where an object is being clamped to a ladder or scaffold (see below).

Generally, the weight of an object to be held by the device should not be too great so as to overcome the biasing force exerted by the biasing means, as this would reduce the clamping effect of the clamping means. The securing means may also be used to provide more secure clamping where heavier objects are being held by the device.

The surface edge to which the device is clampable may be formed by a table, a door, a step ladder, scaffolding, a barrier, a bed, a chair, a wheelchair, a bath, a vehicle panel, or a shelf. The device may be clamped to a surface edge at any angle (for example, vertical, horizontal, or angles between vertical and horizontal), curved, asymmetrical or linear.

### SUMMARY OF THE INVENTION

Objects which may be held in the device are numerous, and include an implement such as a decorating accessory, equipment such as medical equipment or image-capturing equipment (for example, a camera), in particular light equipment which does not overload the device, a household tool, a bottle (such as a wine bottle, held at the edge of a table), a can (such as a paint can), a light, a sign (particularly a temporary sign), a menu, a wine bucket, a vase such as a flower vase, or a kitchen utensil.

In another aspect of the present invention, the holding unit may be used for holding an object such as a fixed, fixable, secured or securable object, for example a stake or tripod. The clamping unit would then be available for clamping the surface edge of a further object which could be any type of object as defined above.

Further features of the present invention will become apparent from the following non-limiting examples. Generally speaking the invention extends to any novel one, or any novel combination, of the features disclosed in this specification (including any accompanying claims and drawings). Moreover unless stated otherwise, any feature disclosed herein may be replaced by an alternative feature serving the same or a similar purpose.

### BRIEF DESCRIPTION OF THE DRAWINGS

The present invention will now be described with reference to the accompanying illustrative drawings, in which:

FIG. 1 is a front perspective view of a clamping device held in a closed (clamping) position according to a first embodiment of the invention;

FIG. 2 is a rear perspective view of the clamping device shown in FIG. 1;

FIG. 3 is a front perspective view of the clamping device shown in FIGS. 1 and 2 but in an open (release) position;

FIG. 4 is a rear perspective view of the clamping device shown in FIG. 3;

FIG. 5 is a side elevation of the clamping device shown in FIGS. 1-4, depicted in use clamped to a table;

FIG. 6 is a side elevation of the clamping device shown in FIGS. 1-4, depicted in use clamped to a ladder;

FIG. 7 is a side elevation of the clamping device shown in FIGS. 1-4, depicted in use clamped to a curved surface;

FIG. 8 is a cross sectional view of a securing means for use with a clamping device according to a second embodiment of the invention;

FIG. 9 is a cross sectional view of the securing means shown in FIG. 8, depicted in use with the clamping device clamped to a surface; and

FIG. 10 is a further section view of the securing means shown in FIGS. 8 and 9, with the clamping device clamped to a ladder.

### DETAILED DESCRIPTION OF THE INVENTION

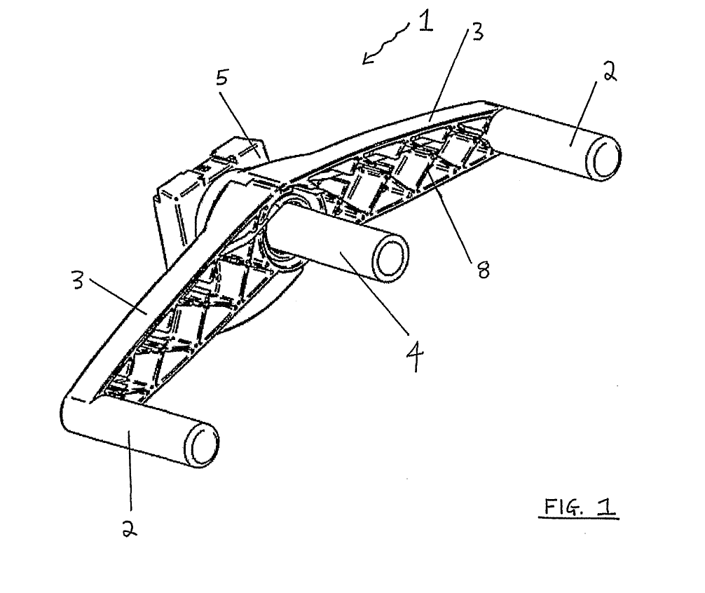

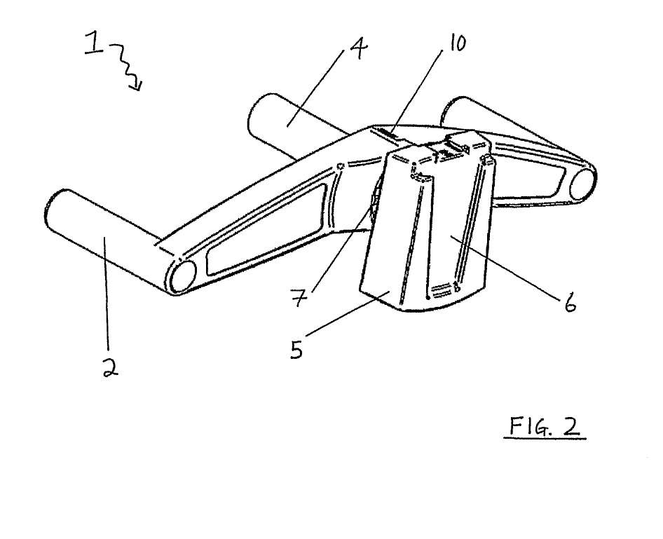

In a first clamping device (or bracket) 1 depicted in FIGS. 1 and 2, tubular clamping members (or fins) 2 extend outwardly from distal ends of the clamping arms 3 which pivot around a central body (internal to structure shown). A further clamping member 4 extends from the central body on one side, while a holding unit 5 extends on the opposite side of the central body.

The holding unit is fully rotatable around a sprung detent mechanism 7 housed with the central body. The holding unit comprises an attachment part 8 for receiving a corresponding attachment part integral with or position on an object to be held by the holding unit.

Objects which could be held by the holding unit are not shown in the accompanying drawings but include any object as described above.

Connecting each clamping arm around the central body is a torsion spring 8 mounted with the clamping arms. The torsion spring naturally maintains the clamping arms in a clamping position with the three clamping members in almost linear alignment. A stop means 10 limits the movement of the clamping arms and maintains a tension (or biasing force) exerted by the torsion spring within the clamping arms.

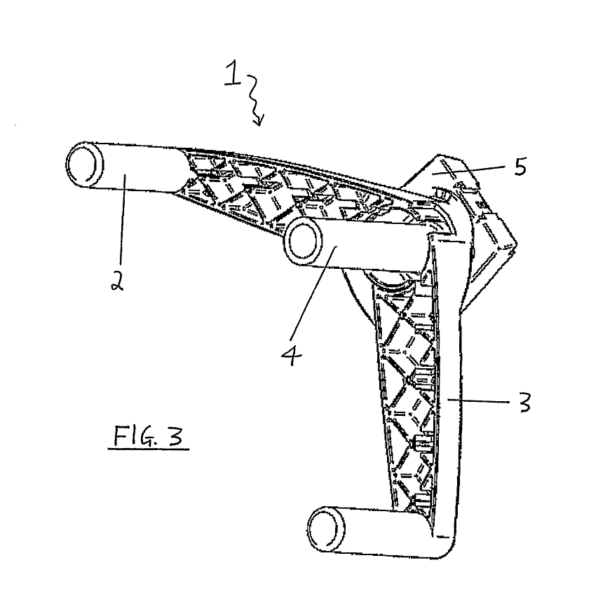

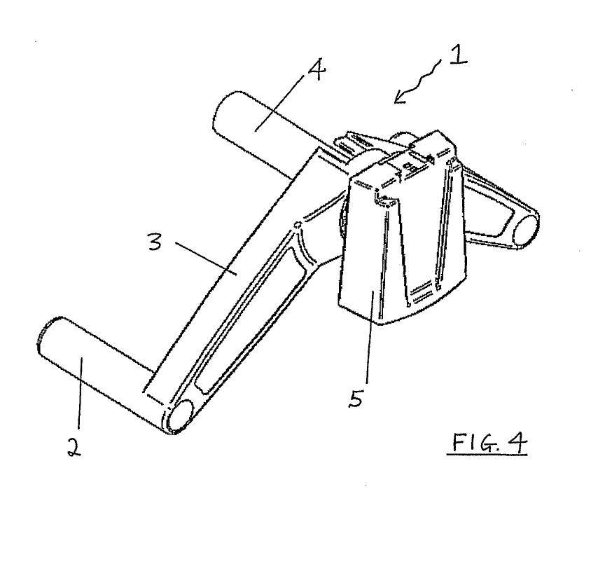

The clamping device 1 is shown in an open (or release) position in FIGS. 3 and 4. In the open position, the clamping arms are held against the biasing force created by the torsion spring.

Once the clamping arms are opened, the clamping device can be offered to a surface edge such that the clamping members located on the clamping arms are positioned on one side of the surface while the clamping member on the central body is positioned on the other side of the surface. The three clamping members thereby form a three-point clamping or anchoring arrangement around the surface edge.

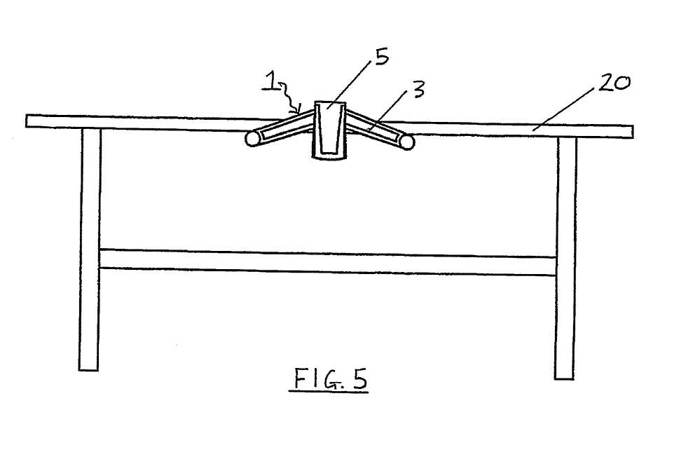

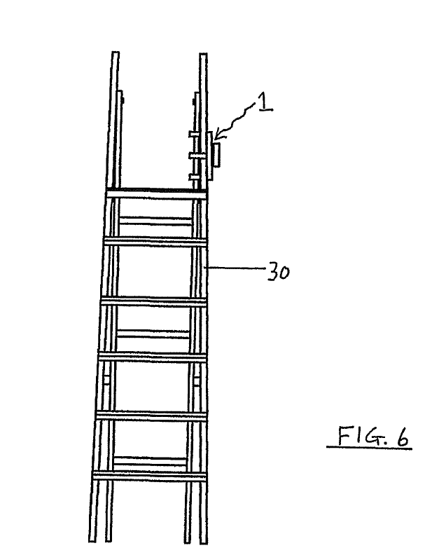

Examples of how the clamping device may be clamped to various surface edges are shown in FIGS. 5 to 7. In FIG. 5, the clamping device is shown clamped to a table 20. In FIG. 6, the clamping device is shown clamped to the side of a ladder 30. In FIG. 7, the clamping device is shown clamped to a curved surface 40.

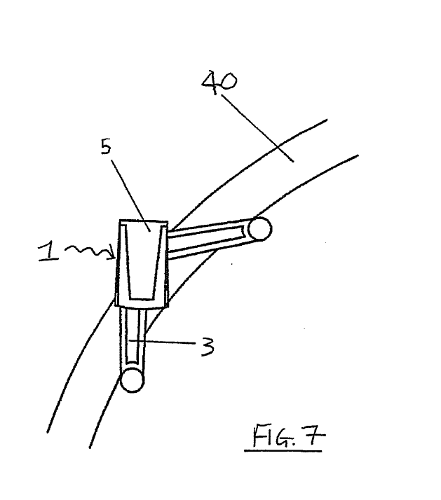

In each of these illustrations, it can be envisaged how an object held in the holding unit will be accessible to a user. For example, when the clamping device is clamped to a ladder, the holding unit may be attached to a decorating accessory such as a paint pot or a paint tray. The accessory will then be easily and safely accessible by the user.

Where it is critical that an object is held securely by the clamping device, or where the weight of the object would adversely affect the biasing force exerted by the torsion spring, a securing means 100, as depicted in FIGS. 8-10, can be used in combination with the clamping device.

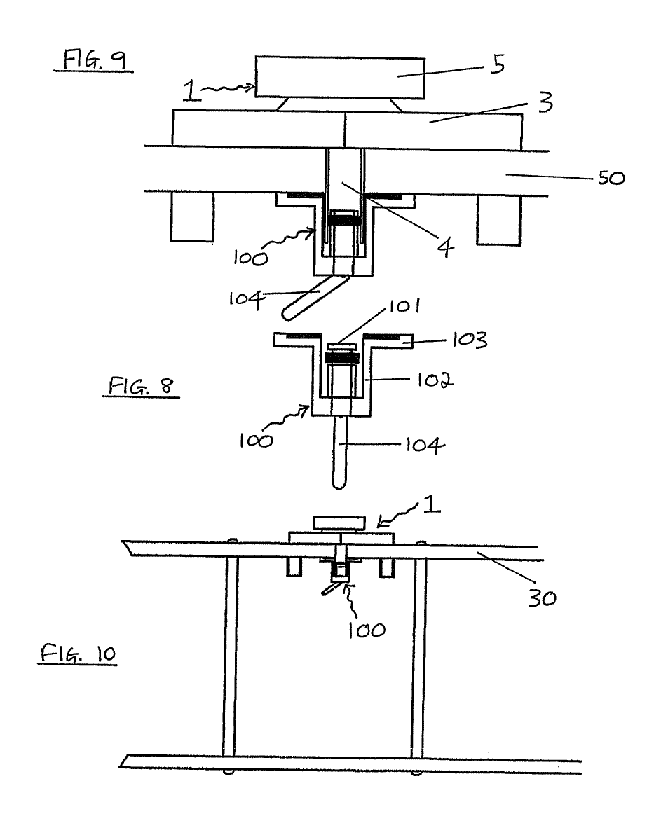

With reference to FIG. 8, the securing means comprises a core plug 101 recessed within a cylindrical casing 102. The casing includes a broad annular base 103 and a lever 104 that actuates the core plug. As shown in FIG. 9, in use the core plug of the securing means is inserted using the lever into a tubular clamping member of the clamping device, with the annular base of the securing means abutting a surface edge 50, after the clamping device has been attached to the surface edge. This arrangement is further illustrated in FIG. 10 where the surface is a ladder. The securing means provides further stability and secures the clamping device to the surface edge.

What is claimed:

1. A clamping device for holding an object at a surface edge, the device comprising: a clamping unit for clamping the device to the surface edge, the clamping unit having two, three or more clamping members which are movable relative to each other from a clamping position to a release position; a biasing means operative to provide a biasing force for biasing the clamping members towards the clamping position; and a holding unit for holding the object, the holding unit being coupled to the clamping unit.

2. The device according to claim 1, wherein the clamping unit and optionally the holding unit are connected to a body.

3. The device according to claim 2, wherein the clamping unit comprises two or more movable clamping arms arranged in a pivotal relationship with each other about the body, each clamping arm comprising a clamping member, for example at an end of each clamping arm distal from the clamping member.

4. The device according to claim 2, wherein a clamping member extends outwardly from the body.

5. The device according to claim 4, wherein the biasing means forces the clamping members on the clamping arms into substantially linear alignment on opposite sides of a centrally located clamping member, for example the clamping member located on the body.

6. The device according to claim 1, further comprising a stop means which limits movement of the clamping members relative to each other.

7. The device according to claim 1, wherein the biasing means comprises a resilient means, for example a spring such as a torsion spring.

8. The device according to claim 1, wherein one or more of the clamping members are tubular or designed for engaging with a particular surface edge to which the device is clampable.

9. The device according to claim 1, wherein one or more of the clamping members comprise or are at least partially covered by a grip-improving material, for example a sleeve of grip-improving material such as a closed cell self-skinning foam.

10. The device according to claim 1, wherein the holding unit is rotatable to allow an object held within the holding unit to be orientated at a chosen angle.

11. The device according to claim 10, wherein the holding unit comprises a stop mechanism, for example a detent mechanism such as a sprung detent mechanism, which operates to restrict free rotation of the holding unit.

12. The device according to claim 10, wherein the holding unit is articulated.

13. The device according to claim 10, wherein the holding unit comprises a ball-and-socket joint.

14. The device according to claim 1, wherein a clamping member comprises or is connected to the holding unit.

15. The device according to claim 1, wherein the holding unit comprises an attachment site onto which the object is releasably attachable.

16. The device according to claim 15, wherein the attachment site comprises one part of a connecting mechanism onto which a corresponding part positioned on, attached to, or integral with the object is connectable.

17. The device according to claim 15, wherein the attachment site comprises a lock mechanism for locking the object into the holding unit.

18. The device according to claim 1, wherein one or more of the clamping members comprise a securing means for securing the device to the surface.

19. The device according to claim 18, wherein the securing means comprises a screwable or a lever-operable core plug attachable to a locking cover plate.

20. The device according to claim 18, wherein the securing means is independent component detachable from the clamping member(s).

21. The device according to claim 20, wherein at least part of the securing means is insertable into a clamping member.

22. The device according to claim 1, wherein the surface edge is formed by a table, a door, a step ladder, scaffolding, a barrier, a bed, a chair, a wheelchair, a bath, a vehicle panel, or a shelf.

23. The device according to claim 1, wherein the surface edge is at any angle (for example, vertical, horizontal, or angles between vertical and horizontal), curved, asymmetrical or linear.

24. The device according to claim 1, wherein the object is an implement, equipment such as medical equipment or image-capturing equipment (such as a camera), a light, a sign including a temporary sign, a menu, a wine bucket, a vase, a household tool, a bottle, a can or a kitchen utensil.
